(19) United States
(12) Patent Application Publication
(10) Pub. No.: US 2019/0353263 A1
(43) Pub. Date: Nov. 21, 2019

(54) POPPET TYPE PNEUMATIC VALVE FOR INFLATION SYSTEM

(71) Applicant: Goodrich Corporation, Charlotte, NC (US)

(72) Inventor: Poly Puthur John, Bangalore (IN)

(21) Appl. No.: 16/033,951

(22) Filed: Jul. 12, 2018

(30) Foreign Application Priority Data
May 17, 2018 (IN) 201811018546

(51) Int. Cl. F16K 15/20

(52) U.S. Cl. CPC F16K 15/207

(57) ABSTRACT

An inflation system is provided and includes a housing assembly defining inlet and command cavities, a poppet disposable within the housing assembly to assume open or closed positions, a pressurized bottle to pressurize the inlet cavity to bias the poppet toward the closed position and a solenoid valve. The solenoid valve is interposable between the pressurized bottle and the command cavity. The solenoid valve is normally closed and selectively openable to permit fluid flow from the pressurized bottle to pressurize the command cavity such that the poppet is biased toward the open position.

### CROSS-REFERENCE TO RELATED APPLICATIONS

This application claims the benefit of Indian Patent Application No. 201811018546, filed May 17, 2018, which is incorporated herein by reference in its entirety.

### BACKGROUND

The following description relates to an inflation system and, more particularly, to an inflation system with a poppet type pneumatic valve.

Pneumatic inflation systems typically use high pressure stored gas to inflate a body. The stored gas needs to be discharged into that body within a specified period of time by the opening of a normally closed valve. This normally closed valve can be a flow isolation valve and can be mechanically or electrically actuated. Electrical actuation uses squib initiators.

In conventional pneumatic inflation systems, a normally closed main valve is sealed to a gas bottle. In its closed position, inlet fluid pressure acts on a spool in an opening direction and the pressure is opposed by mechanical interference and friction between the spool and an actuator piston rod. An electrical squib actuates the pneumatic valve opening. Electrical squibs are single shot devices and are subject to regulatory issues and thus non-pyro type electric initiators are often desired.

Once the main valve is actuated by the electrical squib, the opening position of the valve is sustained by fluid pressure force acting at the spool.

Most pneumatic inflation systems are not pressure balanced, and actuation forces increase with main valve size and operating pressures. Also, the pneumatic valves typically use elastomer O-ring seals for internal leak tightness in closed positions, but this leads to difficulties in achieving good leak tightness at extreme operating temperatures. Moreover, once the valves are actuated, they need to be dismantled and reset to closed positions for further use with a new electrical squib.

### BRIEF DESCRIPTION

According to an aspect of the disclosure, an inflation system is provided and includes a housing assembly defining inlet and command cavities, a poppet disposable within the housing assembly to assume open or closed positions, a pressurized bottle to pressurize the inlet cavity to bias the poppet toward the closed position and a solenoid valve. The solenoid valve is interposable between the pressurized bottle and the command cavity. The solenoid valve is normally closed and selectively openable to permit fluid flow from the pressurized bottle to pressurize the command cavity such that the poppet is biased toward the open position.

In accordance with additional or alternative embodiments, the housing assembly includes first and second housings and a baffle.

In accordance with additional or alternative embodiments, the first housing defines an inlet through which the pressurized bottle pressurizes the inlet cavity and an outlet through which pressurized fluid exits the inlet cavity with the poppet assuming the open position.

In accordance with additional or alternative embodiments, the outlet includes a flow restricting orifice.

In accordance with additional or alternative embodiments, the first housing includes a valve seat that sealably engages with the poppet assuming the closed position.

In accordance with additional or alternative embodiments, the second housing defines a secondary inlet through which the pressurized bottle pressurizes the command cavity with the solenoid valve selectively opened.

In accordance with additional or alternative embodiments, the second housing includes at least one of a removable end cap and an elastic element to apply an elastic bias to the poppet.

In accordance with additional or alternative embodiments, the second housing includes a vent.

In accordance with additional or alternative embodiments, the baffle defines an aperture and the poppet includes a stem, which comprises a first section having a diameter that exceeds a diameter of the aperture and a second section that extends from the first section, through the aperture and into the command cavity.

According to another aspect of the disclosure, an inflation system is provided and includes first and second housings defining inlet and secondary cavities, respectively, a baffle interposed between the first and second housings, a poppet, a pressurized bottle and a solenoid valve. The poppet includes a first piston disposable in the inlet cavity to assume open or closed positions, a second piston disposable to sealably divide the secondary cavity into a command cavity and a dummy cavity, and a stem connectable to the first and second pistons and disposable to sealably extend through the baffle. The pressurized bottle pressurizes the inlet cavity to bias the first piston toward the closed position. The solenoid valve is interposable between the pressurized bottle and the command cavity. The solenoid valve is normally closed and selectively openable to permit fluid flow from the pressurized bottle to pressurize the command cavity such that the second piston is biased to drive the first piston with the stem toward the open position.

In accordance with additional or alternative embodiments, the first housing defines an inlet through which the pressurized bottle pressurizes the inlet cavity and an outlet through which pressurized fluid exits the inlet cavity with the first piston assuming the open position.

In accordance with additional or alternative embodiments, the outlet includes a flow restricting orifice.

In accordance with additional or alternative embodiments, the first housing includes a valve seat that sealably engages with the first piston assuming the closed position.

In accordance with additional or alternative embodiments, the second housing defines a secondary inlet through which the pressurized bottle pressurizes the command cavity with the solenoid valve selectively opened.

In accordance with additional or alternative embodiments, the second housing includes at least one of a removable end cap and an elastic element to apply an elastic bias to the second piston.

In accordance with additional or alternative embodiments, the second housing includes a vent.

In accordance with additional or alternative embodiments, the baffle defines an aperture and the stem includes a first section having a diameter that exceeds a diameter of the aperture and a second section that extends from the first section, through the aperture and into the command cavity.

According to yet another aspect of the disclosure, a method of operating an inflation system is provided and includes pressurizing an inlet cavity with a gas from a gas bottle, maintaining a de-pressurized condition in a command cavity and energizing a solenoid to open a solenoid valve interposed between the gas bottle and the command cavity to pressurize the command cavity. The pressurizing of the command cavity pneumatically driving a poppet to open an outlet of the inlet cavity through which the gas flows.

In accordance with additional or alternative embodiments, the method further includes de-energizing the solenoid during the pressurizing of the command cavity and restricting flows of the gas through the outlet and applying a pressure force acting at the dynamic seal engaging a large diameter section of the poppet to maintain the pneumatic driving of the poppet while de-energizing the solenoid.

In accordance with additional or alternative embodiments, the method further includes at least one of biasing the poppet to close the outlet of the inlet cavity and replacing the gas bottle and removing a cap to expose the poppet, pushing the poppet to close the outlet of the inlet cavity and replacing the gas bottle.

These and other advantages and features will become more apparent from the following description taken in conjunction with the drawings.

### BRIEF DESCRIPTION OF THE DRAWINGS

The subject matter, which is regarded as the disclosure, is particularly pointed out and distinctly claimed in the claims at the conclusion of the specification. The foregoing and other features and advantages of the disclosure are apparent from the following detailed description taken in conjunction with the accompanying drawings in which:

FIG. 1 is a side view of a poppet type pneumatic valve of an inflation system in a closed condition in accordance with embodiments;

FIG. 2 is a side view of the poppet type pneumatic valve of FIG. 1 in an open condition in accordance with embodiments;

FIG. 3 is an enlarged side view of the poppet type pneumatic valve of FIGS. 1 and 2 in accordance with embodiments;

FIG. 4 is an enlarged side view of a vent of the poppet type pneumatic valve of FIGS. 1 and 2 in accordance with embodiments; and

FIG. 5 is a flow diagram illustrating a method of operating an inflation system in accordance with embodiments.

These and other advantages and features will become more apparent from the following description taken in conjunction with the drawings.

### DETAILED DESCRIPTION

As will be described below, a new pneumatic valve system is provided and includes a poppet type valve unit that is operated by a two-way solenoid valve. The pneumatic valve system is pressure balanced, smaller than conventional systems and can be designed to achieve good leak tightness at extreme operating temperatures.

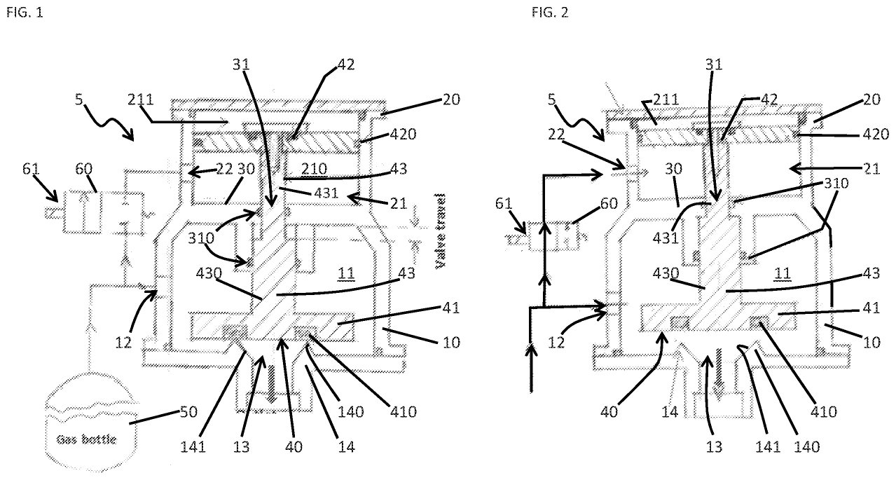

With reference to FIGS. 1 and 2, an inflation system 5 is provided and includes a housing assembly that in turn includes a first housing 10, a second housing 20 and a baffle 30. The first housing 10 is formed to define an inlet cavity 11, an inlet 12, which is fluidly communicative with the inlet cavity 11 and an outlet 13, which is also fluidly communicative with the inlet cavity 11. The second housing 20 is formed to define a secondary cavity 21 and a secondary inlet 22, which is fluidly communicative with the secondary cavity 21. The baffle 30 is interposed between the first housing 10 and the second housing 30 and is formed to define an aperture 31. The aperture 31 extends from the secondary cavity 21 to the inlet cavity 11 and has a diameter. Sidewalls of the aperture 31 and a guide feature disposed about the aperture 31 may be formed to define grooves into which dynamic seals 310 are insertable. The dynamic seals 310 may be provided as O-rings, for example.

The first housing 10 includes a valve seat 14. The valve seat 14 is disposed about the outlet 13 and includes raised features 140 and an inwardly tapered, flow restricting orifice 141.

The inflation system 5 further includes a poppet 40. The poppet 40 includes a first piston 41, a second piston 42 and a stem 43.

The first piston 41 is disposable in the inlet cavity 11 and is configured to assume a closed position (see FIG. 1) or an open position (see FIG. 2) in the inlet cavity 11. The first piston 41 has an exterior or lower face, which is formed to define a groove into which a valve seal 410 is insertable. The valve seal 410 engages with the raised features 140 of the valve seat 14 when the first piston 41 assumes the closed condition such that fluid flow out of the inlet cavity 11 through the outlet 13 is prevented. The valve seal 410 disengages from the raised features 140 when the first piston 410 assumes the open condition such that the fluid flow out of the inlet cavity 11 through the outlet 13 is permitted. The valve seal 410 may be provided as an O-ring, for example.

The second piston 42 is disposable in the secondary cavity 21 and configured to sealably divide the secondary cavity 21 into a command cavity 210 at an interior or lower face of the second piston 42 and a dummy cavity 211 at an exterior or higher face of the second piston 42. The secondary inlet 22 is fluidly communicative with the command cavity 210. A radially outward face of the second piston 42 closely abuts with a sidewall of the second housing 20 and is formed to define a groove into which a dynamic seal 420 is insertable. The dynamic seal 420 seals the command cavity 210 from the dummy cavity 211 along the sidewall of the second housing 20 while permitting movement of the second piston 42. The second seal may be provided as an O-ring, for example.

The stem 43 is connectable to the first piston 41 at a first end thereof and to the second piston 42 at a second end thereof. As such, the poppet 40 moves within the first and second housings 10 and 20 of the housing assembly as a singular element. The stem 43 is disposable to sealably extend through the aperture 31 of the baffle 30 and includes a first section 430, which is proximate to the first piston 41, and a second section 431, which is proximate to the second piston 42. The second section 431 extends from an end of the first section 430, through the aperture 31 and into the command cavity 210. The first section 430 has a diameter that exceeds the diameter of the aperture 31 and the second section 431 has a diameter which is substantially similar to the diameter of the aperture 31. Thus, while the second section 431 can be slid through the aperture 31 (and the dynamic seals 310), the end of the first section 430 acts as a mechanical stop when it impinges upon the baffle 30.

In accordance with embodiments, the dynamic seal 310 engaging with the first section 430 is larger than the dynamic seal 310 engaging with the second section 431 and is smaller than the effective seal diameter of the valve seal 410.

The stem 43 may be integrally connected or fastened to one or both of the first piston 41 and the second piston 42. For example, the stem 43 may be integrally connected to the first piston 41 and fastened to the second piston 42. The fastening may include a static seal.

As shown in FIG. 1, a valve travel distance is the distance between the end of the first section 430 and the lower face of the baffle 30 when the first piston 41 assumes the closed condition.

The inflation system 5 also includes a pressurized bottle 50 and a solenoid valve 60. The pressurized bottle 50 contains a pressurized gas, which can be used to inflate an inflatable element coupled to the outlet 13. The pressurized bottle 50 is directly fluidly coupled to the inlet 12 such that the inlet cavity 11 is pressurized. This pressurization of the inlet cavity 11 serves to bias the first piston 41 toward assuming the closed condition. The pressurized bottle 50 is also indirectly fluidly coupled to the secondary inlet 22, with the solenoid valve 60 being fluidly interposable between the pressurized bottle 50 and the command cavity 210 or removed from that position. That is, the solenoid valve 60 may be configured to be normally closed and selectively openable. When the solenoid valve 60 is normally closed, the solenoid valve 60 prevents fluid flow from the pressurized bottle 50 to the secondary inlet 22 and the command cavity 210. Conversely, when the solenoid valve 60 is selectively opened, the solenoid valve 60 permit fluid flow from the pressurized bottle 50, through the secondary inlet 22 and into the command cavity 210.

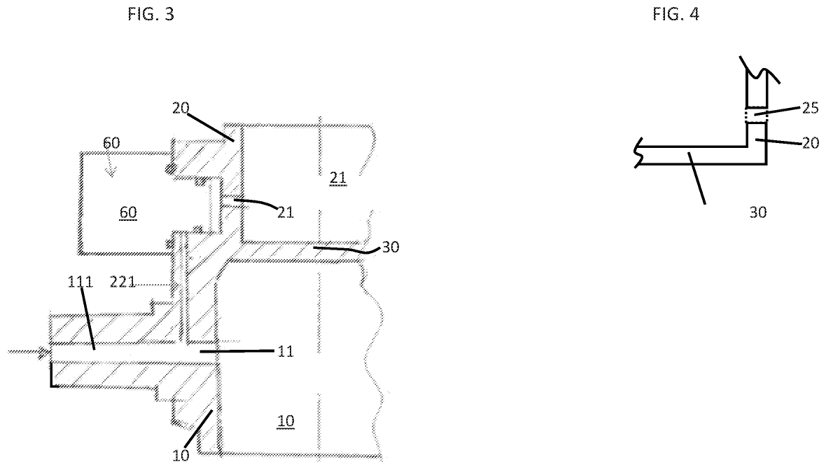

In accordance with embodiments and with reference to FIG. 3, fluid couplings between the pressurized bottle 50 and the inlet 11 and between the pressurized bottle 50, the solenoid valve 60 and the secondary inlet 22 may be provided through respective manifolds of the first and second housings 10 and 20 (e.g., along inlet line 111 or pilot pressure line 221).

The solenoid valve 60 may include a solenoid 61 or, in some cases, an electrical or pyrotechnic squib. When the solenoid 61 is de-energized as shown in FIG. 1, the solenoid 61 is disposed between the pressurized bottle 50 and the secondary inlet 22. When the solenoid 61 is energized as shown in FIG. 2, the solenoid 61 is removed from its original or normal position and permits the fluid flow from the pressurized bottle 50, through the secondary inlet 22 and into the command cavity 210.

Once the solenoid 61 is energized and the fluid flow from the pressurized bottle 50, through the secondary inlet 22 and into the command cavity 210 is permitted, the fluid flow pressurizes the command cavity 210 and develops higher pressure force than the inlet cavity 11. This pressurization of the command cavity 210 also exceeds a pressure inside the dummy cavity 211 and thus applies a bias to the second piston 42. This bias on the second piston 42 drives the first piston 41 with the stem 43 toward assuming the open position relative to the valve seat 14. At this point, the pressurized fluid inside the inlet cavity 11 begins to flow out of the inlet cavity 11 through the outlet 13 (and into the inflatable element).

With the pressurized fluid flowing out of the inlet cavity 11 through the outlet 13 (and into the inflatable element), the solenoid 61 can be de-energized. At this point, the fluid flowing through the outlet 13 interacts with the inwardly tapered, flow restricting orifice 141 to apply a bias onto the first piston 41. This bias on the first piston 41 along with the pressure force acting on the dynamic seal 310 engaging the first section 430 of the stem 43, the friction between dynamic seal 420 and the sidewalls of the second housing 20 and the friction between the second section 431 of the stem 43 and the dynamic seal 310 maintains the poppet 40 in the position at which the first piston 41 assumes the open condition. In this way, the inflation system 5 is pneumatically balanced in the open condition.

Once the pressurized gas is spent, the inflation system 5 is reset. This can be accomplished by removing an end cap 23 of the second housing 20 and pushing down onto the second piston 42 to return the poppet 40 to its original position (at which the first piston 41 assumes the closed condition) and replacing the pressurized bottle. As an additional or alternative example, the second housing 20 may also include an elastic element, which applies an elastic bias onto the second piston 42 that automatically returns the poppet 40 to its original position (at which the first piston 41 assumes the closed condition).

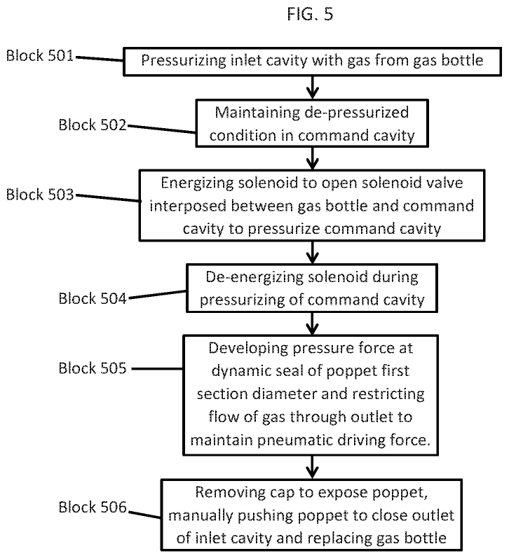

In accordance with embodiments and with reference to FIG. 4, the second housing 20 may also include a vent system especially in cases of long-pressure hold times. As shown in FIG. 4, the vent system may include a vent 25 to vent leaked gas from the solenoid valve 60 during the pressure holding times.

With reference to FIG. 5, a method of operating the inflation system 5 is provided. The method includes pressurizing an inlet cavity with a gas from a gas bottle (block 501), maintaining a de-pressurized condition in a command cavity (block 502) and energizing a solenoid to open a solenoid valve interposed between the gas bottle and the command cavity to pressurize the command cavity (block 503) to thereby pneumatically drive a poppet to open an outlet of the inlet cavity through which the gas flows. The method further includes de-energizing the solenoid during the pressurizing of the command cavity (block 504) and restricting flows of the gas through the outlet and developing a pressure force at the dynamic seal 310 engaging the stem 430 to maintain the pneumatic driving of the poppet while de-energizing the solenoid (block 505). The method may also include removing a cap to expose the poppet, pushing the poppet to close the outlet of the inlet cavity and replacing the gas bottle (block 506) or biasing the poppet to close the outlet of the inlet cavity and replacing the gas bottle.

In accordance with embodiments, the seals described herein are designed to ensure sealing stress within yield limits of the sealing material. Soft polymer sealing materials can be used to achieve good leak tightness over wide temperature ranges. For the pressure balancing dynamic seals, either elastomeric O-ring seals or spring-energized polymer lip seals (e.g., OMINI™ seals) can be used. A central screw of the fastening can be designed to withstand various pressure loads.

While the disclosure is provided in detail in connection with only a limited number of embodiments, it should be readily understood that the disclosure is not limited to such disclosed embodiments. Rather, the disclosure can be modified to incorporate any number of variations, alterations, substitutions or equivalent arrangements not heretofore described, but which are commensurate with the spirit and scope of the disclosure. Additionally, while various embodiments of the disclosure have been described, it is to be understood that the exemplary embodiment(s) may include only some of the described exemplary aspects. Accordingly, the disclosure is not to be seen as limited by the foregoing description, but is only limited by the scope of the appended claims.

What is claimed is:

1. An inflation system, comprising:
a housing assembly defining inlet and command cavities;
a poppet disposable within the housing assembly to assume open or closed positions;
a pressurized bottle to pressurize the inlet cavity to bias the poppet toward the closed position; and
a solenoid valve interposable between the pressurized bottle and the command cavity,
the solenoid valve being normally closed and selectively openable to permit fluid flow from the pressurized bottle to pressurize the command cavity such that the poppet is biased toward the open position.

2. The inflation system according to claim 1, wherein the housing assembly comprises first and second housings and a baffle interposed between the first and second housings.

3. The inflation system according to claim 2, wherein the first housing defines:
an inlet through which the pressurized bottle pressurizes the inlet cavity, and
an outlet through which pressurized fluid exits the inlet cavity with the poppet assuming the open position.

4. The inflation system according to claim 3, wherein the outlet comprises a flow restricting orifice.

5. The inflation system according to claim 2, wherein the first housing comprises a valve seat that sealably engages with the poppet assuming the closed position.

6. The inflation system according to claim 2, wherein the second housing defines a secondary inlet through which the pressurized bottle pressurizes the command cavity with the solenoid valve selectively opened.

7. The inflation system according to claim 2, wherein the second housing comprises a removable end cap.

8. The inflation system according to claim 2, wherein the second housing comprises a vent.

9. The inflation system according to claim 2, wherein:
the baffle defines an aperture, and
the poppet comprises a stem, which comprises a first section having a diameter that exceeds a diameter of the aperture and a second section that extends from the first section, through the aperture and into the command cavity.

10. An inflation system, comprising:
first and second housings defining inlet and secondary cavities, respectively;
a baffle interposed between the first and second housings;
a poppet comprising a first piston disposable in the inlet cavity to assume open or closed positions, a second piston disposable to sealably divide the secondary cavity into a command cavity and a dummy cavity, and a stem connectable to the first and second pistons and disposable to sealably extend through the baffle;
a pressurized bottle to pressurize the inlet cavity to bias the first piston toward the closed position; and
a solenoid valve interposable between the pressurized bottle and the command cavity,
the solenoid valve being normally closed and selectively openable to permit fluid flow from the pressurized bottle to pressurize the command cavity such that the second piston is biased to drive the first piston with the stem toward the open position.

11. The inflation system according to claim 10, wherein the first housing defines:
an inlet through which the pressurized bottle pressurizes the inlet cavity, and
an outlet through which pressurized fluid exits the inlet cavity with the first piston assuming the open position.

12. The inflation system according to claim 11, wherein the outlet comprises a flow restricting orifice.

13. The inflation system according to claim 10, wherein the first housing comprises a valve seat that sealably engages with the first piston assuming the closed position.

14. The inflation system according to claim 10, wherein the second housing defines a secondary inlet through which the pressurized bottle pressurizes the command cavity with the solenoid valve selectively opened.

15. The inflation system according to claim 10, wherein the second housing comprises a removable end cap.

16. The inflation system according to claim 10, wherein the second housing comprises a vent.

17. The inflation system according to claim 10, wherein:
the baffle defines an aperture, and
the stem comprises a first section having a diameter that exceeds a diameter of the aperture and a second section that extends from the first section, through the aperture and into the command cavity.

18. A method of operating an inflation system, the method comprising:
pressurizing an inlet cavity with a gas from a gas bottle;
maintaining a de-pressurized condition in a command cavity; and
energizing a solenoid to open a solenoid valve interposed between the gas bottle and the command cavity to pressurize the command cavity,
the pressurizing of the command cavity pneumatically driving a poppet to open an outlet of the inlet cavity through which the gas flows.

19. The method according to claim 18, further comprising:
de-energizing the solenoid during the pressurizing of the command cavity; and
restricting flows of the gas through the outlet and applying a pressure force acting at the dynamic seal engaging a large diameter section of the poppet to maintain the pneumatic driving of the poppet while de-energizing the solenoid.

20. The method according to claim 18, further comprising removing a cap to expose the poppet, pushing the poppet to close the outlet of the inlet cavity and replacing the gas bottle.
